(19) United States
(12) Patent Application Publication
(10) Pub. No.: US 2011/0114025 A1
(43) Pub. Date: May 19, 2011

(54) Selectively Sealable Pet Feeder

(76) Inventor: John McMurphy, Otis, CO (US)

(21) Appl. No.: 12/949,333

(22) Filed: Nov. 18, 2010

Related U.S. Application Data
(60) Provisional application No. 61/262,845, filed on Nov. 19, 2009.

(51) Int. Cl. A01K 5/00

(52) U.S. Cl. 119/51.5; 119/61.55; 119/61.56

(57) ABSTRACT

A pet feeder is provided that conveniently holds both food and water. The pet feeder includes a bowl adapted to hold pet food and the remainder of the pet feeder's interior is adapted to hold water. As such, water spreads evenly throughout the pet feeder. Thus, the pet feeder provides a stable and spill-resistant pet feeder.

### CROSS REFERENCE TO RELATED APPLICATIONS

This application claims the benefit of U.S. Patent Application No. 61/262,845, filed Nov. 19, 2009, the entire disclosure of which is incorporated by reference herein. This patent application is also related to U.S. patent application Ser. No. 29/280,558, filed May 31, 2007, now U.S. Pat. No. D579,724, and Ser. No. 29/340,775, filed Jul. 24, 2009, now U.S. Pat. No. D621,560, which are incorporated by reference in their entirety herein.

### FIELD OF THE INVENTION

Embodiments of the present invention are generally related to pet accessories. More specifically, one embodiment of the present invention is a pet feeder that holds food and water that may include lids for sealing food and/or water within the pet feeder.

### BACKGROUND OF THE INVENTION

Pet feeders, such as dog bowls, are commonly used to store food and water. One drawback of some food and water bowls of the prior art is that they do not prevent the pet from tipping the bowl and spilling food and water therefrom. It is thus desirable to provide a pet feeder having improved stability.

Further, pet owners typically utilize separate containers for food and water. It is often necessary or desirable, however, to keep the pet's food and water together. Although some pet feeders are adapted to hold both food and water, these feeders become unstable when an unequal amount of food and water are stored in the feeder. Further, some pet feeders for holding both food and water are elevated, which reduces the stability and, thus, increases the likelihood that the feeder will be tipped and/or knocked over. Thus, it is important to provide a pet feeder configured to stably hold both food and water.

Thus, it is a long felt need to provide a pet feeder that avoids the above-mentioned deficiencies. The embodiments of the present invention outlined below provide a spill/tip-resistant, stable pet feeder that accommodates both food and water.

### SUMMARY OF THE INVENTION

It is one aspect of the present invention to provide a pet feeder that holds both food and water. Further, the pet feeder's design provides enhanced stability that prevents the feeder from tipping and associated food and water spillage. More specifically, the pet feeder of one embodiment comprises a food receptacle that is suspended from the lower surface of the pet feeder, i.e., the surface that contacts a horizontal surface when water is added to the pet feeder, it will flow beneath and around the food receptacle to provide a consistent weight about the lower surface. The pet feeder of one embodiment includes two openings, one associated with a receptacle for holding food and the other that is associated with a receptacle for holding water. In one embodiment of the present invention, the pet feeder preferably includes removable lids that selectively interconnect to the openings to seal the food and water within the pet feeder. The pet feeder of one embodiment also includes at least one handle that facilitates carrying and transport of the pet feeder.

It is another aspect of embodiments of the present invention to reduce spillage. For example, embodiments of the pet feeder include a splashguard or lip that is integrated either along the perimeter of the openings or adjacent to the upper edge of the openings. The splashguard helps impede spilling that occurs when a pet is drinking.

It is yet another aspect of embodiments of the present invention to provide a skid-resistant pet feeder. Here, the base of the pet feeder may include a skid/slip-resistant material, such as rubber that minimizes movement of the pet feeder. For example, the pet feeder may include a plurality of rubber feet or a rubber ring surrounding the perimeter of base.

The pet feeder as described herein may be made of numerous rigid and/or resilient materials, such as, a light-weight synthetic material, a polymeric material, including food-grade plastic and stain-resistant plastic, or a metal alloy, including stainless steel. Preferably, the pet feeder is made from a strong and durable material. The pet feeder is made from a material that is easy to maintain and clean, for example, a dishwasher safe material. The pet feeder may also be treated with any number of products/coatings, such as, anti-odor, anti-microbial, and anti-mildew/mold coatings to prevent bacterial growth, odor and stains. One of skill in the art will appreciate that the pet feeder may be integrally formed as one piece or may be formed separately and then assembled. One of skill in the art will appreciate that the pet feeder of the present invention is relatively safe because the number of parts is minimized. More specifically, some pet waterers/feeders have potentially harmful parts, such as motors, filters, electrical wiring, etc., that are dangerous to a pet's health and safety.

It is thus one aspect of the present invention to provide a pet feeder, comprising a substantially planar base interconnected to a plurality of upwardly extending sidewalls and endwalls that define a container receptacle; a top having a plurality of openings, said top interconnected to an upper portion of said plurality of upwardly extending sidewalls and endwalls; a first opening positioned on said top, wherein said first opening provides access to a first receptacle, wherein said first receptacle is positioned below said first opening and defined by said base and said plurality of sidewalls and endwalls, and wherein said first receptacle is adapted to hold at least one of a food product and a water; and a second opening positioned on said top, wherein said second opening provides access to a second receptacle, wherein said second receptacle is positioned below said second opening and sized to fit within at least a portion of said first receptacle, and wherein said second receptacle is adapted to hold at least one of said food product and water.

It is still yet another aspect of the present invention to provide a pet feeder, comprising a base; a first sidewall extending from said base; a second sidewall extending from said base and positioned opposite from said first sidewall; a first end wall associated with said base, said first sidewall, and a second sidewall; a second end wall associated with said base positioned opposite from said first end wall, and associated with said first sidewall and a second sidewall; a top wall interconnected to said first sidewall, said second side wall, said first end wall, and said second wall, said top wall having a first opening and a second opening; a food receptacle comprising a sidewall that is associated with said first opening; and a water receptacle that is defined by said first sidewall, said second side wall, said first end wall, said second wall, and said sidewall of said food receptacle, said water receptacle being accessed by said second opening.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of the pet feeder of one embodiment of the present invention that holds food and water;

FIG. 2 is a cross-sectional view of the pet feeder of FIG. 1;

FIG. 3 is a top plan view of the pet feeder of FIG. 1;

FIG. 4 is a perspective view of the pet feeder of another embodiment of the present invention configured as a spill-resistant pet feeder;

FIG. 5 is a perspective view of the pet feeder of another embodiment of the present invention;

FIG. 6 is a top plan view of FIG. 5;

FIG. 7 is a bottom plan view of FIG. 5;

FIG. 8 is a left elevation view of FIG. 5;

FIG. 9 is a front elevation view of FIG. 5; and

FIG. 10 is a right elevation view of FIG. 5.

To assist in the understanding of one embodiment of the present invention, the following list of components and associated numbering found in the drawings is provided:

| # | Component |
|---|---|
| 2 | Pet feeder |
| 6 | Base |
| 10 | Side wall |
| 14 | End wall |
| 18 | Food receptacle |
| 22 | Water receptacle |
| 26 | Top |
| 30 | Opening |
| 34 | Base |
| 38 | Side wall |
| 42 | Interior space |
| 46 | Lid |
| 50 | Top |
| 54 | Side wall |
| 58 | Grasping element |
| 62 | Handle |
| 66 | Lip |
| 70 | Indentation |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

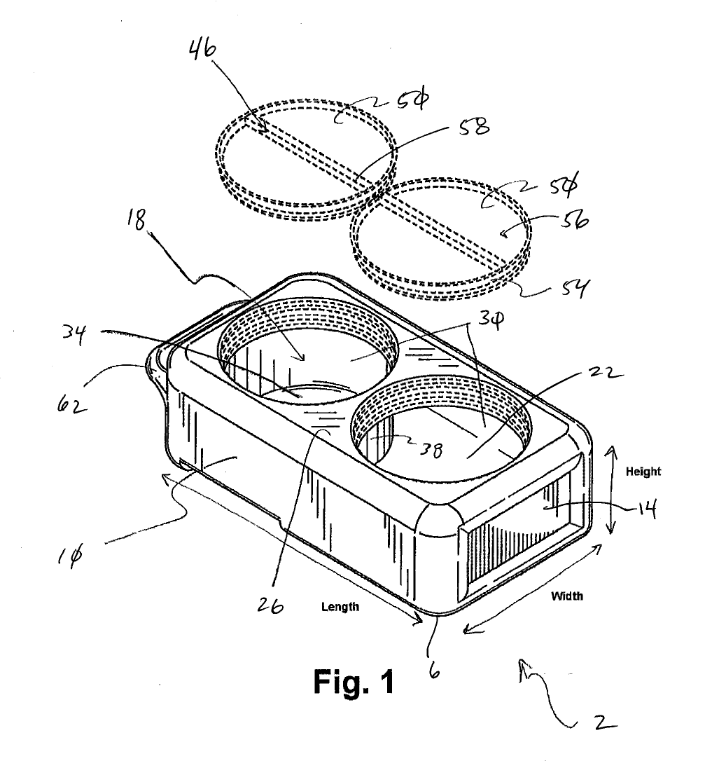

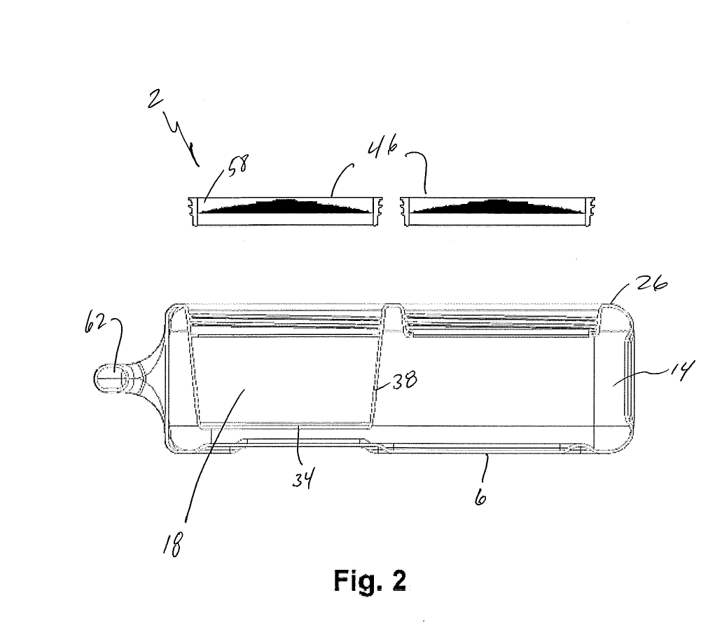

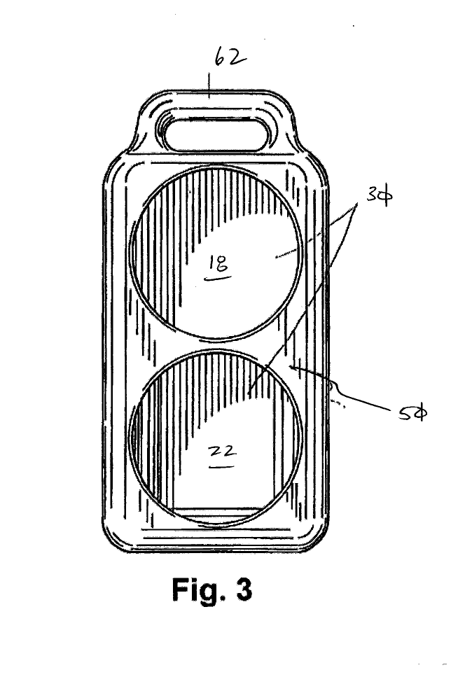

Referring now to FIGS. 1-3, a pet feeder 2 of one embodiment of the present invention is shown that comprises a base 6 associated with a plurality of upwardly extending sidewalls 10 and endwalls 14 that defines a receptacle 18 adapted to hold pet food and a receptacle for holding water 22. The height, length, and width of the pet feeder are dimensionally configured to provide a pet feeder having a desired storage capacity. For example, small pets require a smaller quantity of food and water and large pets require a larger quantity of food and water. Moreover, in some embodiments, the height of the pet feeder 2 may be increased to provide a better feeding position for aging/disabled pets. For example, a larger yet aging pet may require a taller feeder in order to feed without stressing/straining the animal's neck and back. Further, it is envisioned that the pet feeder 2 provide means for adjusting the height of the pet feeder, such as extendable legs. Thus, one of skill in the art will appreciate that the feeder of the present invention may be sized to accommodate a variety of pet sizes. As such, the pet feeder 2 is capable of providing a healthy and comfortable feeding position for pets of various sizes.

The pet feeder 2 of one embodiment of the present invention further comprises a top 26 having two openings 30. In a preferred embodiment, the openings 30 are circular and provide the pet access to food and water. One of skill in the art will appreciate that the shape and size of the opening(s) may vary to accommodate a variety of different sized pets and to provide the pet easy access to the food and water within the pet feeder. Preferably, the openings are large enough that the pet can easily reach the food and water stored within the pet feeder.

The pet feeder of one embodiment may further include a food bowl/receptacle 18 associated with one opening of the pet feeder. The receptacle 18 comprises a circular base 34 and a cylindrical or conical sidewall 38 that circumferentially extends from the base to form the receptacle 18. The circumference of the receptacle 18 is sized and shaped to correspond to the size and shape of one of the openings 30 in the top 26 of the pet feeder 2. One of skill in the art will appreciate that alternative bowl shapes/geometries may be used. In one embodiment, the receptacle 18 is configured to fit within at least a portion of the pet feeder 2. The receptacle 18 may be formed integrally with the pet feeder 2 or the receptacle 18 may be formed separate from the pet feeder 2 and then permanently or selectively interconnected thereto. That is, it is contemplated that the receptacle 18 may be selectively removable from the pet feeder 2. Moreover, one of skill in the art will appreciate that water may be stored in the bowl as well.

In the embodiment shown, the one opening 30 provides access to water. The remaining interior space 42 of the pet feeder 2 is filled with food or water, but preferably water. As water enters the opening 30, it will fill the interior space, which includes the space below the food receptacle 18 (if applicable) and the space around the food receptacle 18. That is, the pet feeder 2 is designed such that water surrounds the receptacle 18 and spreads evenly throughout the pet feeder 2 to provide a stable and spill-resistant feeder. Additionally, regardless of how much food or water is in the pet feeder, the pet feeder remains stable because the water will shift and redistribute evenly. Thus, the pet feeder 2 remains stable without requiring auxiliary stabilizing components. Alternatively, a divider may be located in the interior space that prevents water from contacting the receptacle 18 or a portion thereof.

The pet feeder 2 of one embodiment of the present invention is also capable of storing more water than conventional feeders because there is little unused internal volume. Moreover, unlike conventional feeders that provide equal space for both food and water, the contemplated pet feeder provides a larger volume for storing water than food. This is advantageous because pets generally require more water than food. In addition, the pet feeder is more convenient as the pet owner does not need to re-fill the water as frequently due to the increased water capacity of the pet feeder.

The pet feeder 2 of one embodiment of the present invention may also comprise removable lids 46 for selectively sealing the contents stored within the pet feeder 2. The lids 46 include a top 50 and a downwardly extending sidewall 54. The lids 46 may be attached to the openings 30 by any suitable securing methods, such as, a snap-on feature, a hinge, a rotating post, clasp, hook and loop, sliding rails, a magnetic element, or threads. A sealing device, such as a gasket or o-ring, may be used in conjunction with the one or both of the lids 46. The lids 46 are configured in any shape/geometry to complement the shape/geometry of the openings 30. The lids 46 may be transparent or opaque to enable the pet owner to view the contents stored within the pet feeder. The lids 46 may further include an extending grasping element 58 for assisting the pet owner in removing the lids 46 from the pet feeder 2. In one embodiment, the lids 46 include a grasping element 58 that is integrally formed along the diameter of the top 50 of the lid 46 for easily grasping and removing the lid 46. In another embodiment (not shown) the grasping element is configured as a tab positioned along the outer edge of the lid. One of skill in the art will appreciate that lids 46 also help to keep the contents of the feeder fresh.

In addition, the pet feeder of one embodiment includes a handle 62 for easy and convenient carrying and transport. As shown, the handle 62 of one embodiment is interconnected to one side of the pet feeder 2. One of skill in the art will appreciate that the handle 62 may comprise a hinge or other feature to enable the handle to be rotated/retracted to a closed position. One of skill in the art will also appreciate that the pet feeder may comprise any number of handles to facilitate lifting and carrying. Moreover, it is envisioned that the pet feeder 2 comprise a shoulder strap for easy carrying.

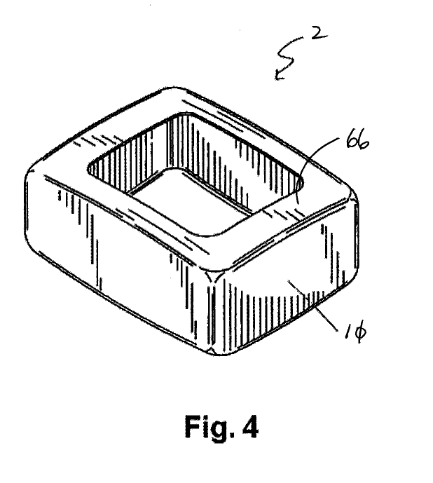

Referring now to FIG. 4, an alternative embodiment of the present invention is shown that is configured as a spill-resistant pet waterer. The pet waterer includes a rectangular container comprising a base 6 that is integrally associated with a rectangular sidewall 10 defining a container for holding water. One of skill in the art will appreciate that the length, width, and height of the pet waterer is adaptable to a variety of shapes and sizes to accommodate pets of all sizes. The pet waterer of one embodiment of the present invention further comprises one opening 30 for holding water. The opening 30 may be sized to provide the pet with easy access for drinking. The opening 30 may be associated with a lip 66 that helps prevent the escape of fluids from the pet feeder 2. As discussed in conjunction with the pet feeder embodiment above, the pet waterer may further comprise a handle and/or a lid.

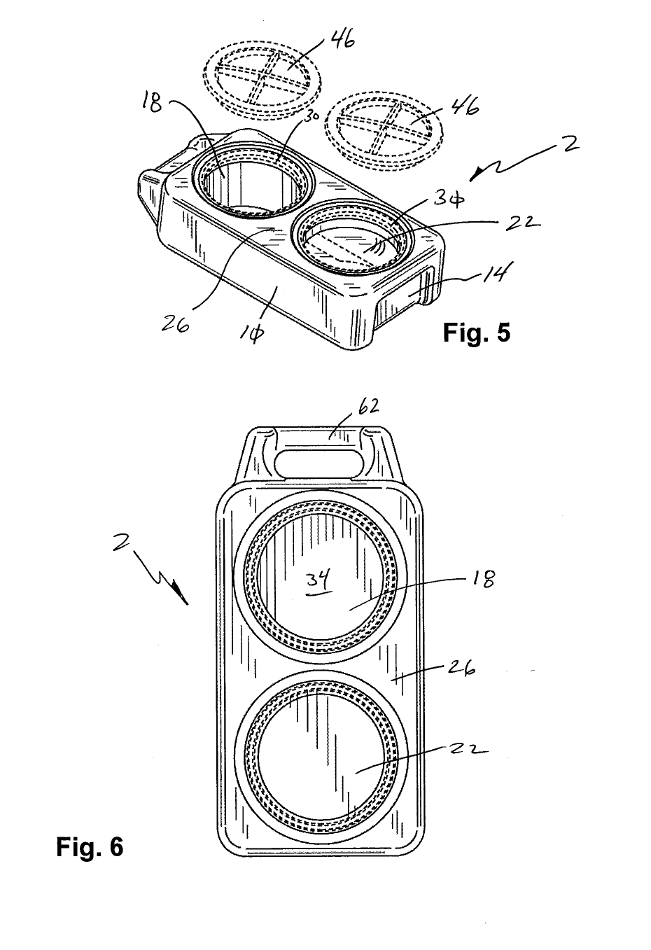

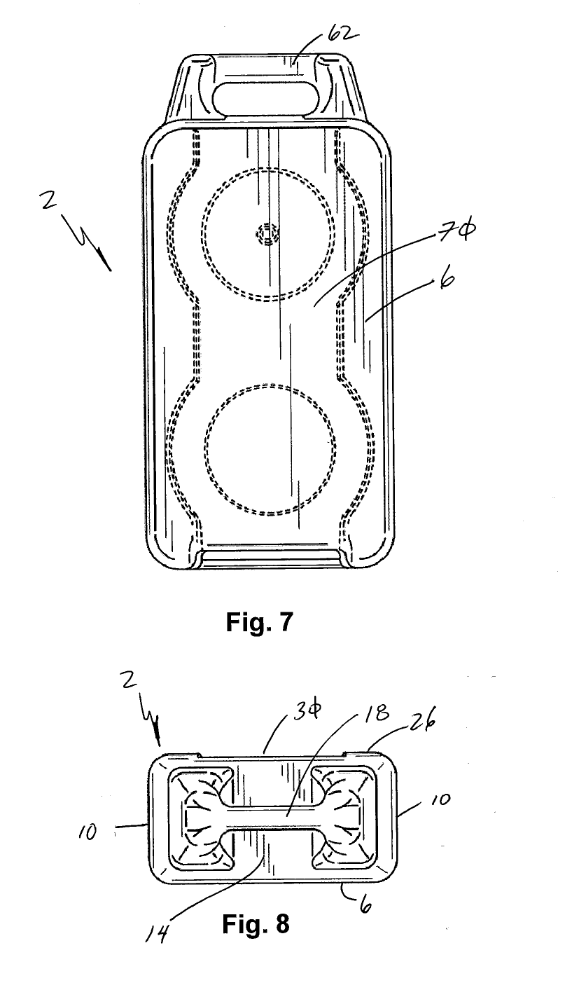

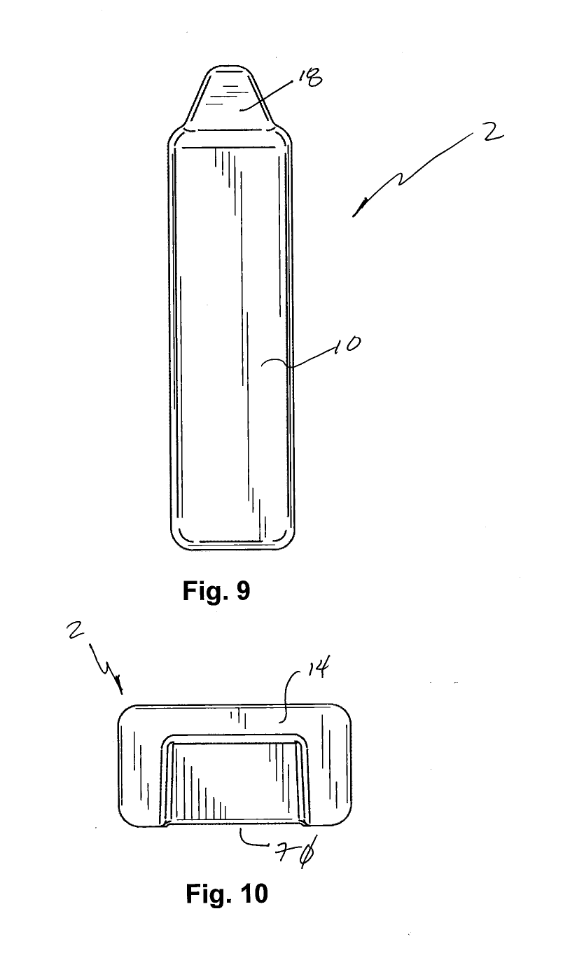

FIGS. 5-10 show another embodiment of the present invention that is similar to that of FIGS. 1-3. More specifically, a food receptacle 2 is provided having two openings 30, wherein one opening 30 is associated with a food receptacle 18 and another opening 30 is associated with a water receptacle 22. The opening 30 may be selectively closed and opened with a lid 46 that is similar to that described above. The lid 46 may also include a grasping element 58. One difference between the embodiment of FIG. 5-10 and those described above is an indentation 70 incorporated in the base 6 that is designed to receive the lids 46 of a sealed container that is positioned beneath the food receptacle 2 in a stacked configuration. That is, the indentations 70 allow for food receptacles 2 to be stacked and an efficiently locked relative to each other. As in other embodiments described above, this embodiment of the present invention includes a handle 62. After placed in a predetermined location for feeding, the lids 46 are removed to provide access to food in the food receptacle 18 and water in the water receptacle 22.

Those skilled in the art will appreciate that the sidewalls 10 or end walls 14 may include one or more drains or openings that may receive a hose that allows access to the interior portion of the pet feeder 2 to facilitate cleaning. In one embodiment, the drain is located adjacent to the handle. Still, other embodiments of the present invention provide a pet feeder 2 wherein the top portion 26 is removable from the sidewalls 10 and the end walls 14 to facilitate cleaning of the receptacle. Still other embodiments of the present invention provide a food receptacle 18 that is removable from the top 26. For example, the food receptacle 18 may include external threads that mate with threads associated with the food receptacle's opening. The food receptacle 18 would thus have internal threads or other engaging mechanisms for attaching with the lid 46.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. However, it is to be expressly understood that such modifications and alterations are within the scope and spirit of the present invention, as set forth in the following claims.

What is claimed is:

1. A pet feeder, comprising:
a substantially planar base interconnected to a plurality of upwardly extending sidewalls and endwalls that define a container receptacle;
a top interconnected to an upper portion of said plurality of upwardly extending sidewalls and endwalls;
a first opening positioned on said top, wherein said first opening provides access to a first receptacle, wherein said first receptacle is positioned below said first opening and defined by said base and said plurality of sidewalls and endwalls, and wherein said first receptacle is adapted to hold at least one of a food product and a water; and
a second opening positioned on said top, wherein said second opening provides access to a second receptacle, wherein said second receptacle is positioned below said second opening and sized to fit within at least a portion of said first receptacle, and wherein said second receptacle is adapted to hold at least one of said food product and water.

2. The pet feeder of claim 1, further comprising at least one handle interconnected to at least one of said base, said top, and said plurality of sidewalls and end walls, wherein said handle is adapted for carrying said pet feeder.

3. The pet feeder of claim 1, further comprising a plurality of lids configured to interconnect to at least one of said first and second openings and adapted to selectively secure said at least one food product and water within said pet feeder.

4. The pet feeder of claim 1, wherein said second receptacle has a bottom surface that coincides with said base.

5. The pet feeder of claim 1, wherein said second receptacle has a bottom surface that is spaced from said base.

6. A pet feeder, comprising:
a base;
a first sidewall extending from said base;
a second sidewall extending from said base and positioned opposite from said first sidewall;
a first end wall associated with said base, said first sidewall, and a second sidewall;
a second end wall associated with said base positioned opposite from said first end wall, and associated with said first sidewall and a second sidewall;
a top wall interconnected to said first sidewall, said second side wall, said first end wall, and said second wall, said top wall having a first opening and a second opening;
a food receptacle comprising a sidewall that is associated with said first opening; and
a water receptacle that is defined by said first sidewall, said second side wall, said first end wall, said second wall, and said sidewall of said food receptacle, said water receptacle being accessed by said second opening.

7. The pet feeder of claim 6, wherein said food receptacle is further comprised of a bottom surface that is spaced from said base.

8. The pet feeder of claim 6, wherein said food receptacle is further comprised of a bottom surface that is interconnected to said base.

9. The pet feeder of claim 6, wherein said food receptacle is selectively interconnected to said top wall.

10. The pet feeder of claim 6 wherein said base has an indentation.

11. The pet feeder of claim 6, further comprising at least one handle interconnected to said first end wall.

12. The pet feeder of claim 6, further comprising a first lid for interconnection to said first opening and a second lid for interconnection to said second opening.

13. The pet feeder of claim 12, wherein said first lid and said second lid are selectively interconnected to said top by way of threads, hinges, or a snap fit.
